(19) United States
(12) Patent Application Publication
(10) Pub. No.: US 2021/0253333 A1
(43) Pub. Date: Aug. 19, 2021

(54) PACKAGING MATERIAL FOR CARTON PRODUCTS AND PACKAGING METHOD THEREOF

(71) Applicant: NAN YA PLASTICS CORPORATION, Taipei (TW)

(72) Inventors: TE-CHAO LIAO, TAIPEI (TW); CHUN-CHE TSAO, TAIPEI (TW); Chen-Ho Lai, TAIPEI (TW)

(21) Appl. No.: 17/022,273

(22) Filed: Sep. 16, 2020

(30) Foreign Application Priority Data
Feb. 19, 2020 (TW) 109105238

(51) Int. Cl. B65D 85/10; B65B 11/58; B65B 19/22; C08L 23/12

(52) U.S. Cl. CPC B65D 85/1072; B65B 11/58; B65B 19/22; C08L 2203/162; C08L 2207/066; C08L 2205/03; C08L 23/12

(57) ABSTRACT

A packaging material for carton products and a packaging method thereof are provided. The packaging material includes an inner packaging film and an outer packaging film. The inner packaging film includes a first polypropylene material and a first resin additive. The first polypropylene material has a first melting point. The melting point of the first resin additive is not greater than the first melting point. The outer packaging film includes a second polypropylene material, a second resin additive, and a slip agent. The second polypropylene material has a second melting point. The first melting point is greater than the second melting point. An absolute value of a difference between the first melting point and the second melting point is between 10° C. and 40° C. The melting point of the second resin additive is not greater than the second melting point.

### CROSS-REFERENCE TO RELATED PATENT APPLICATION

This application claims the benefit of priority to Taiwan Patent Application No. 109105238, filed on Feb. 19, 2020. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a packaging material, and more particularly to a packaging material for carton products and packaging method thereof.

### BACKGROUND OF THE DISCLOSURE

In the prior art, most of packaging methods for cigarette boxes are to use a large carton to package a plurality of small-sized cigarette boxes, and then to wrap a transparent film on the large carton.

With the increasing competition in the tobacco industry, in order to reduce costs, products without large carton packaging have been launched on the market. Conventional packaging methods for this type of products are mainly to use a biaxially stretched polypropylene film coated with materials such as polyvinylidene chloride or acrylic on both sides thereof to directly package a plurality of small-packaged cigarette boxes, so that a mutual adhesion between an outer packaging film and an inner packaging film of a small-packaged cigarette box can be avoided.

However, the outer packaging film having a coating layer is prone to release pungent gases (i.e., vinyl chloride monomer) at a high temperature, which will have adverse effects on human health and an external environment. Furthermore, a manufacturing of the outer packaging film having the coating layer requires a double-sided coating equipment to be completed, thus increasing a production cost of the carton product.

### SUMMARY OF THE DISCLOSURE

In response to the above-referenced technical inadequacies, the present disclosure provides a packaging material for carton products and packaging method thereof.

In one aspect, the present disclosure provides a packaging material for a carton product. The packaging material includes an inner packaging film and an outer packaging film. The inner packaging film is used for packaging an outer surface of the carton product, in which a composition of the inner packaging film includes: a first polypropylene material and a first resin additive. The first polypropylene material has a first melting point. The first resin additive is mixed in the first polypropylene material. The first resin additive is not a polypropylene material, and a melting point of the first resin additive is not greater than the first melting point. Based on a total weight of the inner packaging film being 100 wt %, a content range of the first polypropylene material is not less than 50 wt %, and a content range of the first resin additive is between 0.1 wt % and 10 wt %. The outer packaging film is used for packaging an outer surface of the inner packaging film away from the carton product, in which a composition of the outer packaging film includes: a second polypropylene material, a second resin additive, and a slip agent. The second polypropylene material has a second melting point, in which the first melting point is greater than the second melting point, and an absolute value of a difference between the first melting point and the second melting point is between 10° C. and 40° C. The second resin additive is mixed in the second polypropylene material. The second resin additive is also not a polypropylene material, a material type of the second resin additive is different from a material type of the first resin additive, and a melting point of the second resin additive is not greater than the second melting point. The slip agent is dispersed in the second polypropylene material in a form of a plurality of particles. Based on a total weight of the outer packaging film being 100 wt %, a content range of the second polypropylene material is not less than 35 wt %, a content range of the second resin additive is between 5 wt % and 50 wt %, and a content range of the slip agent is between 0.1 wt % and 10 wt %. A peeling force between the outer packaging film and the inner packaging film is not greater than 0.5N.

In another aspect, the present disclosure provides a packaging method for carton products, including: providing a plurality of carton products; providing a plurality of inner packaging films; in which a composition of each of the inner packaging films includes: a first polypropylene material and a first resin additive mixed in the first polypropylene material; in which the first polypropylene material has a first melting point, the first resin additive is not a polypropylene material, and a melting point of the first resin additive is not greater than the first melting point; in which based on a total weight of the inner packaging film being 100 wt %, a content range of the first polypropylene material is not less than 50 wt %, and a content range of the first resin additive is between 0.1 wt % and 10 wt %; packaging the plurality of inner packaging films respectively on outer surfaces of the plurality of carton products to form a plurality of inner packaging structures; providing an outer packaging film; in which a composition of the outer packaging film includes: a second polypropylene material, a second resin additive mixed in the second polypropylene material, and a slip agent dispersed in the second polypropylene material in a form of a plurality of particles; in which the second polypropylene material has a second melting point, the first melting point is greater than the second melting point, and an absolute value of a difference between the first melting point and the second melting point is between 10° C. and 40° C.; in which the second resin additive is also not a polypropylene material, a material type of the second resin additive is different from a material type of the first resin additive, and a melting point of the second resin additive is not greater than the second melting point; in which based on a total weight of the outer packaging film being 100 wt %, a content range of the second polypropylene material is not less than 35 wt %, a content range of the second resin additive is between 5 wt % and 50 wt %, and a content range of the slip agent is between 0.1 wt % and 10 wt %; and packaging the outer packaging film on an outer side of the plurality of inner packaging structures to accommodate the plurality of inner packaging structures; in which a peeling force between the outer packaging film and each of the inner packaging films is not greater than 0.5N.

In conclusion, the packaging material for carton products and the packaging method thereof of the present disclosure can effectively prevent the inner packaging film and the outer packaging film from sticking to each other, and can improve the self-adhesiveness of the inner packaging film and the self-adhesiveness of the outer packaging film by virtue of “adjusting a melting point matching relationship between the inner packaging film and the outer packaging film”, by virtue of “respectively introducing different resin additives into the inner packaging film and the outer packaging film”, and by virtue of “introducing a slip agent into the outer packaging film”.

Furthermore, since neither the inner packaging film nor the outer packaging film of the present disclosure has a coating layer, the technical defects in the prior art of “packaging films being easy to release pungent gas” and “the need to add double-sided coating equipment in production” can also be effectively improved.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The present disclosure will become more fully understood from the following detailed description and accompanying drawings.

FIG. 1 is a schematic diagram (I) of a packaging method for carton products according to an embodiment of the present disclosure.

FIG. 2 is a schematic diagram (II) of the packaging method for the carton products according to the embodiment of the present disclosure.

FIG. 3 is a partial enlarged view of an inner packaging film of FIG. 2.

FIG. 4 is a schematic diagram (III) of the packaging method for the carton products according to the embodiment of the present disclosure.

FIG. 5 is a schematic diagram (IV) of the packaging method for the carton products according to the embodiment of the present disclosure.

FIG. 6 is a schematic diagram (V) of the packaging method for the carton products according to the embodiment of the present disclosure.

FIG. 7 is a partial enlarged view of an outer packaging film of FIG. 6.

FIG. 8 is a schematic diagram (VI) of the packaging method for the carton products according to the embodiment of the present disclosure.

FIG. 9 is a schematic diagram (VII) of the packaging method for the carton products according to the embodiment of the present disclosure.

FIG. 10 is a schematic diagram (VIII) of the packaging method for the carton products according to the embodiment of the present disclosure.

FIG. 11 is a cross-sectional view taken along a line XI-XI of FIG. 10.

FIG. 12 is a partial enlarged view of region XII of FIG. 11.

FIG. 13 is a schematic diagram showing a separation state of the outer packaging film and the inner packaging film of FIG. 12.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

### Packaging Material for Carton Products

An embodiment of the present disclosure provides a packaging material M for carton products, which can be used to package a plurality of carton products P into a group of products, thereby improving transportation efficiency of the carton products or improving marketability of the carton products. The packaging material M for the carton products includes: a plurality of inner packaging films 100 and an outer packaging film 200.

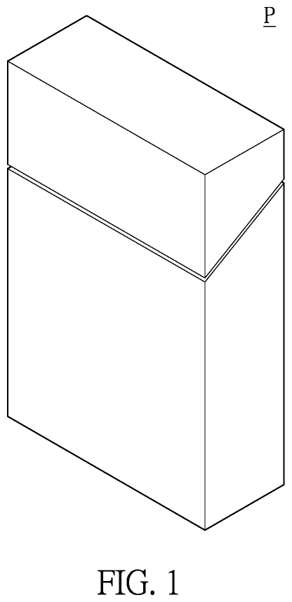

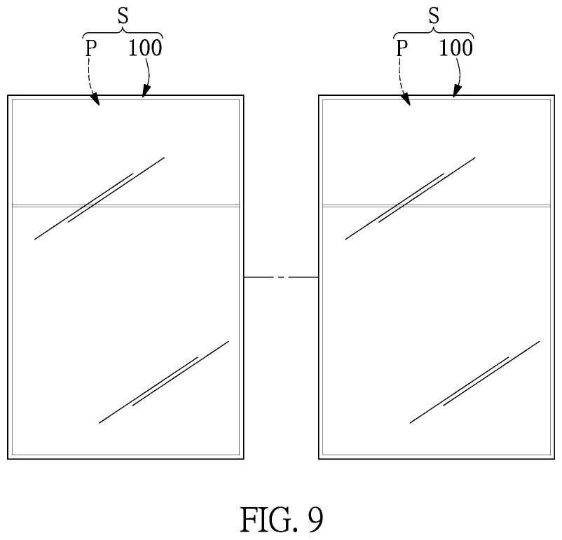

As shown in FIG. 1 to FIG. 5 and FIG. 9, the plurality of inner packaging films 100 can be used to respectively package outer surfaces of the plurality of carton products P to respectively form a plurality of inner packaging structures S. That is, each of the inner packaging films 100 can be used to package the outer surface of one corresponding carton product P, so that each of the inner packaging structures S includes one carton product P and one inner packaging film 100 packaged on the outer surface of the one carton product P.

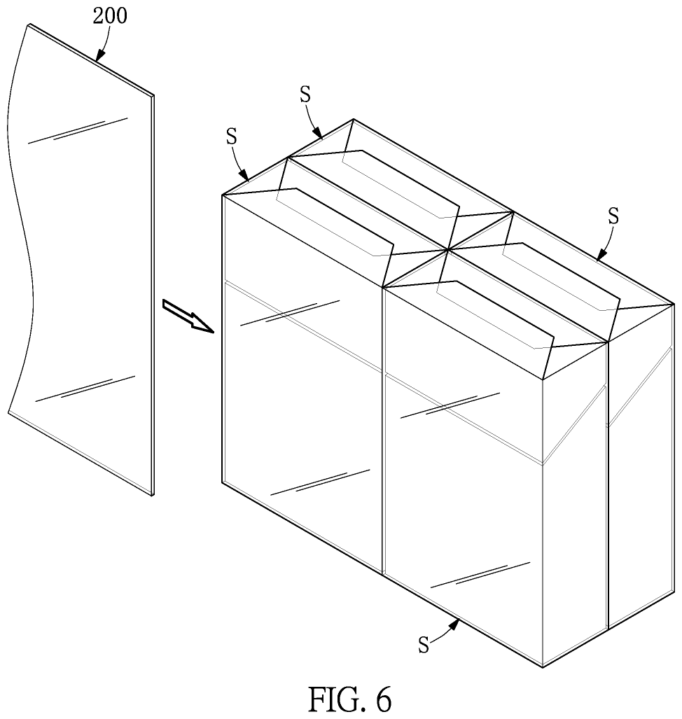

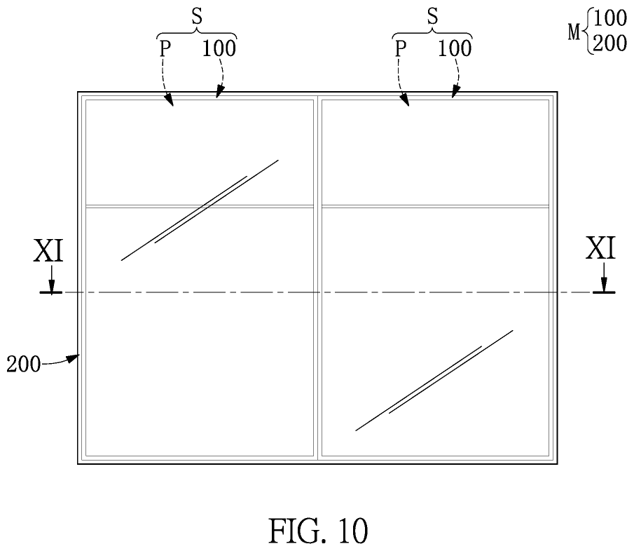

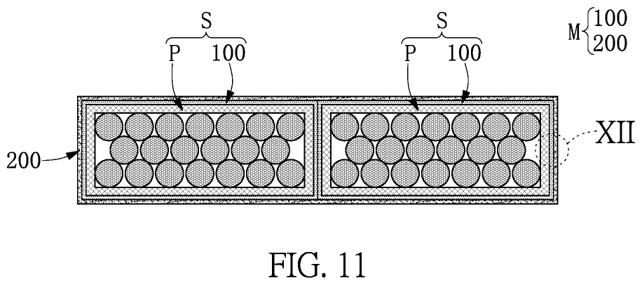

As shown in FIG. 6 to FIG. 8 and FIG. 10 to FIG. 13, the outer packaging film 200 can be used to package an outer side of the plurality of inner packaging structures S to accommodate the plurality of inner packaging structures S, thereby packaging the plurality of carton products P into a group of products. In other words, the outer packaging film 200 can be used to package the outer surfaces of the plurality of inner packaging films 100 away from the plurality of carton products P, and the outer packaging film 200 is in contact with the plurality of inner packaging films 100 as shown in FIG. 11.

In the present embodiment, the carton product P is a cigarette box, but the present disclosure is not limited thereto. For example, the carton product P may also be a carton product for packaging food or other items.

Furthermore, a quantity of the carton products P in the present embodiment is illustrated by taking a group of four carton products as an example, but the present disclosure is not limited thereto. For example, in the packaging of general cigarette boxes, cigarette boxes are usually packed in a group of ten carton products.

It is worth mentioning that, in each of the inner packaging structures S, the inner packaging film 100 is firstly packaged on the outer surface of the carton product P through a heat-sealing film process. After the plurality of inner packaging structures S are packaged, the outer packaging film 200 can be then packaged on the outside of the plurality of inner packaging structures S through the heat-sealing film process. The heat-sealing film process may be, for example, using a heat-sealing film machine to heat the packaging films 100 and 200 to cause the packaging films 100 and 200 to shrink, thereby producing a packaging effect.

Process parameters of the heat-sealing film process (i.e., heat-sealing temperature) can be adjusted according to product design requirements, and the present disclosure is not limited thereto. For example, the heat-sealing temperature of the heat-sealing film process may be, for example, between 120° C. and 160° C.

In addition, it is worth mentioning that, in conventional packaging materials of carton products, an additional coating layer (i.e., an acrylic coating layer or a polyvinylidene chloride coating layer) is usually applied on a surface of the outer packaging film, so that the outer packaging film and the inner packaging film will not stick to each other. However, the outer packaging film having the coating layer is prone to release pungent gases (i.e., vinyl chloride monomer) at a high temperature, which will have adverse effects on human health and an external environment. Furthermore, the manufacturing of the outer packaging film having the coating layer requires a double-sided coating equipment to be completed, thus increasing a production cost of the carton product.

Based on the foregoing technical defects, an objective of the embodiment of the present disclosure is to: provide a packaging material M for carton products, which can effectively avoid the phenomenon of sticking between the inner packaging film 100 and the outer packaging film 200 by virtue of “adjusting a melting point matching relationship between the inner packaging film 100 and the outer packaging film 200”, by virtue of “respectively introducing different resin additives into the inner packaging film 100 and the outer packaging film 200”, and by virtue of “introducing a slip agent into the outer packaging film 200”. Furthermore, since neither the inner packaging film 100 nor the outer packaging film 200 of the present embodiment has a coating layer, the above-mentioned technical defects of easy release of pungent gases and the need to add double-sided coating equipment in production can also be effectively improved.

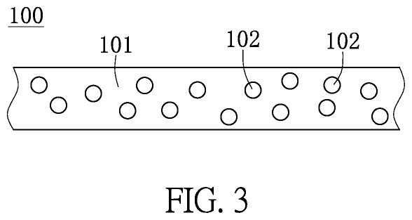

In order to achieve the above objective, in the present embodiment, a composition of each of the inner packaging films 100 includes: a first polypropylene material 101 and a first resin additive 102 as shown in FIG. 3. The first polypropylene material 101 has a first melting point. The first resin additive 102 is mixed in the first polypropylene material 101, the first resin additive 102 is not a polypropylene material, and a melting point of the first resin additive 102 is not greater than the first melting point of the first polypropylene material 101.

The first melting point of the first polypropylene material 101 is between 140° C. and 160° C., and the melting point of the first resin additive 102 is between 130° C. and 160° C., and is preferably between 130° C. and 140° C., which is not greater than the first melting point.

More specifically, in terms of material selection, the first resin additive 102 is poly(methyl methacrylate) (PMMA), a melting point of PMMA is between 130° C. and 140° C., and a glass transition temperature of PMMA is between 100° C. and 110° C. Accordingly, a peeling force (degree of adhesion) of each of the inner packaging films 100 itself can be improved by virtue of the introduction of the first resin additive 102 and the selection of its melting point. In the present embodiment, the peeling force of each of the inner packaging films 100 itself is between 1.2N and 8.0N, but the present disclosure is not limited thereto.

In terms of content range, based on a total weight of the inner packaging film 100 being 100 wt %, a content range of the first polypropylene material 101 is not less than 50 wt %, and a content range of the first resin additive 102 is between 0.1 wt % and 10 wt %. In other words, the main matrix material of the inner packaging film 100 is polypropylene, and the introduction of the first resin additive 102 can improve the self-adhesiveness of the inner packaging film 100 after heat sealing.

It should be noted that if the content range of the first resin additive 102 is greater than an upper limit of the above content range (i.e., greater than 10 wt %), the first resin additive 102 cannot be uniformly mixed in the first polypropylene material 101. Conversely, if the content range of the first resin additive 102 is less than a lower limit of the above content range (i.e., less than 0.1 wt %), the first resin additive 102 cannot generate a significant effect in the first polypropylene material. 101, that is, the first resin additive 102 cannot improve the self-adhesiveness of the inner packaging film 100 after heat sealing.

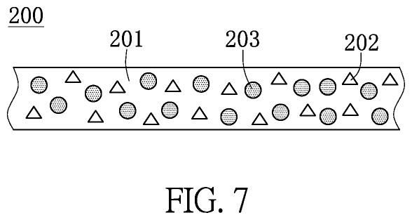

Furthermore, the outer packaging film 200 can be used to package the plurality of inner packaging structures S to accommodate the plurality of inner packaging structures S as shown in FIG. 6. In the present embodiment, a composition of the outer packaging film 200 includes a second polypropylene material 201, a second resin additive 202, and a slip agent 203 as shown in FIG. 7. The second resin additive 202 is mixed in the second polypropylene material 201, and the slip agent 203 is dispersed in the second polypropylene material 201 in the form of a plurality of particles. In other words, the second polypropylene material 201, the second resin additive 202, and the slip agent 203 are uniformly mixed with each other.

The second polypropylene material 201 has a second melting point. The first melting point of the first polypropylene material 101 is greater than the second melting point of the second polypropylene material 201, and an absolute value of a difference between the first melting point and the second melting point is between 10° C. and 40° C.

In addition, the second resin additive 202 is also not a polypropylene material, a material type of the second resin additive 202 is different from a material type of the first resin additive 102, and a melting point of the second resin additive 202 is not greater than the second melting point of the second polypropylene material 201.

More specifically, the second melting point of the second polypropylene material 201 is between 120° C. and 140° C., and the melting point of the second resin additive 202 is between 95° C. and 140° C., which is not greater than the second melting point.

In terms of material selection, the second resin additive 202 is at least one material selected from the group consisting of high-density polyethylene (HDPE), low-density polyethylene (LDPE), linear low-density polyethylene (LLDPE), and ethylene-vinyl acetate copolymer (EVA).

The melting point of high-density polyethylene (HDPE) is between 126° C. and 136° C., the melting point of low density polyethylene (LDPE) is between 108° C. and 126° C., the melting point of linear low density polyethylene (LLDPE) is between 110° C. and 125° C., and the melting point of ethylene-vinyl acetate copolymer (EVA) is approximately 99° C.

That is, in the present embodiment, the melting point of the second resin additive 202 (95° C. to 140° C.) is substantially not greater than the melting point of the first resin additive 102 (130° C. to 160° C.), but the present disclosure is not limited thereto. Furthermore, the material type of the second resin additive 202 is also different from the material type of the first resin additive 102. That is, the resin additives introduced into the outer packaging film 200 and the inner packaging film 100 are resin materials with different properties.

Accordingly, a peeling force (degree of adhesion) of the outer packaging film 200 itself can be improved by virtue of the introduction of the second resin additive 202 and the selection of its melting point. In the present embodiment, the peeling force of the outer packaging film 200 itself is between 2.0N and 10.0N, but the present disclosure is not limited thereto.

In addition, the slip agent 203 is dispersed in the second polypropylene material in a form of a plurality of particles, an average particle size of the slip agent 203 ranges from 0.15 micrometers to 1.5 micrometers. The slip agent is at least one material selected from the group consisting of acrylic particles, silica particles, and polydimethylsiloxane particles.

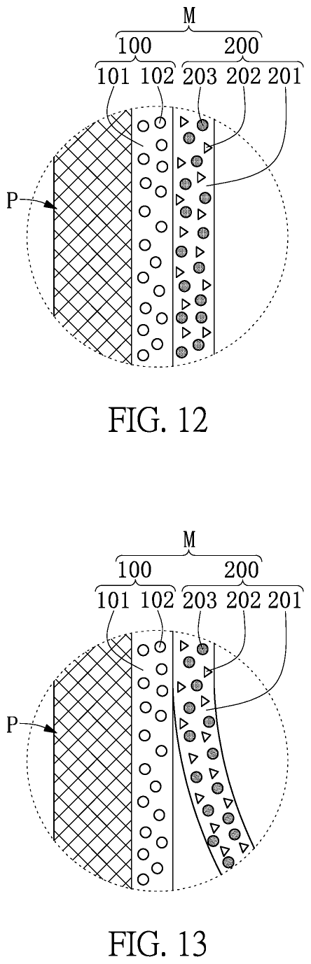

As shown in FIG. 12 and FIG. 13, according to the difference between the first polypropylene material 101 and the second polypropylene material 201 in the selection of melting point, the difference between the first resin additive 102 and the second resin additive 202 in the selections of material type and melting point, and the introduction of the slip agent 203, the peeling force between the outer packaging film 200 and the inner packaging film 100 after heat sealing can be effectively reduced, thereby alleviating the problem that the outer packaging film 200 and the inner packaging film 100 stick to each other.

More specifically, since the conventional outer packaging film and the inner packaging film are made of polypropylene materials, the conventional outer packaging film and the inner packaging film are prone to sticking to each other after heat sealing.

In the present embodiment, since the first melting point of the first polypropylene material 101 is greater than the second melting point of the second polypropylene material 201, the outer packaging film 200 can first absorb heat and be melted during heat sealing, and a melting degree of the inner packaging film can be reduced. Accordingly, the problem that the outer packaging film 200 and the inner packaging film 100 stick to each other after heat sealing can be improved.

In addition, since the resin additives respectively introduced into the outer packaging film 200 and the inner packaging film 100 are resin materials with different properties and different melting points, the degree of mutual adhesion between the outer packaging film 200 and the inner packaging film 100 after heat sealing can also be effectively reduced.

In addition, since the slip agent 203 is further introduced into the outer packaging film 200, a surface energy of the outer packaging film 200 can be reduced, and a surface roughness of the outer packaging film 200 can be improved. Accordingly, the degree of mutual adhesion between the outer packaging film 200 and the inner packaging film 100 after heat sealing can be further effectively reduced.

In the present embodiment, a peeling force between the outer packaging film 200 and the inner packaging film 100 is not greater than 0.5N, and preferably between 0.01N and 0.40N.

The test method of the above-mentioned peeling force (or adhesive force) may be, for example, using a peeling force tester to perform a peeling test on two film materials that are attached to each other.

In terms of content range, based on a total weight of the outer packaging film 200 being 100 wt %, a content range of the second polypropylene material 201 is not less than 35 wt %, a content range of the second resin additive 202 is between 5 wt % and 50 wt %, and a content range of the slip agent 203 is between 0.1 wt % and 10 wt %. In other words, the main matrix material of the outer packaging film 200 is polypropylene, and the second resin additive 202 also occupies a certain proportion, which helps to reduce the overall melting point of the outer packaging film 200.

It should be noted that if the content range of the second resin additive 202 is greater than an upper limit of the above content range (i.e., greater than 50 wt %), the second resin additive 202 cannot be uniformly mixed in the second polypropylene material 201. Conversely, if the content range of the second resin additive 202 is less than a lower limit of the above content range (i.e., less than 5 wt %), the second resin additive 202 cannot generate a significant effect in the second polypropylene material 201. That is, the second resin additive 202 cannot improve the self-adhesiveness of the outer packaging film 200 after heat sealing, and cannot reduce the degree of mutual adhesion between the outer packaging film 200 and the inner packaging film 100.

It is worth mentioning that, in the present embodiment, a thickness range of each of the inner packaging films 100 may be, for example, between 15 micrometers and 50 micrometers, and a thickness range of the outer packaging film 200 may be, for example, between 15 micrometers and 50 micrometers. Furthermore, each of the inner packaging films 100 and the outer packaging film 200 is not coated with an additional coating layer (i.e., an acrylic coating layer or a polyvinylidene chloride coating layer). In addition, in the present embodiment, the inner packaging film 100 and the outer packaging film 200 are both biaxially oriented polypropylene films (BOPP films), but the present disclosure is not limited thereto.

### Packaging Method for Carton Products

The above is a relevant description of the packaging material for carton products of the present embodiment, and a packaging method for carton products will be described below according to an embodiment of the present disclosure.

The present embodiment also discloses a packaging method for carton products. The packaging method for the carton products includes step S110, step S120, step S130, step S140, and step S150. It should be noted that the order of the steps and the actual operation way described in the present embodiment can be adjusted according to requirements and are not limited to those described in the present embodiment.

As shown in FIG. 1, the step S110 includes: providing a plurality of carton products P. In the present embodiment, the carton product P is a cigarette box, but the present disclosure is not limited thereto. For example, the carton product P may also be a carton product for packaging food or other items.

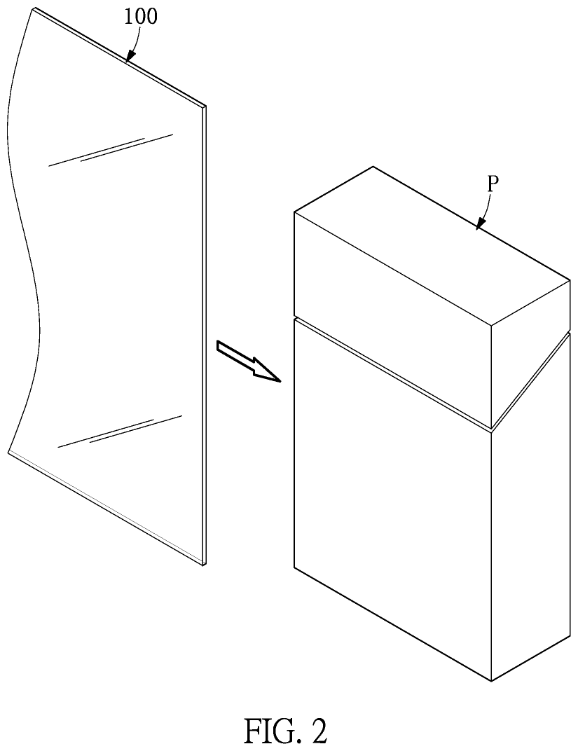

As shown in FIG. 2 and FIG. 3, the step S120 includes: providing a plurality of inner packaging films 100, in which a composition of each of the inner packaging films 100 includes: a first polypropylene material 101 and a first resin additive 102 mixed in the first polypropylene material 101. The first polypropylene material 101 has a first melting point, the first resin additive 102 is not a polypropylene material, and a melting point of the first resin additive 102 is not greater than the first melting point.

Based on a total weight of the inner packaging film 100 being 100 wt %, a content range of the first polypropylene material 101 is not less than 50 wt %, and a content range of the first resin additive is between 0.1 wt % and 10 wt %. In the present embodiment, the first melting point of the first polypropylene material 101 is between 140° C. and 160° C., and the melting point of the first resin additive 102 is between 130° C. and 160° C.

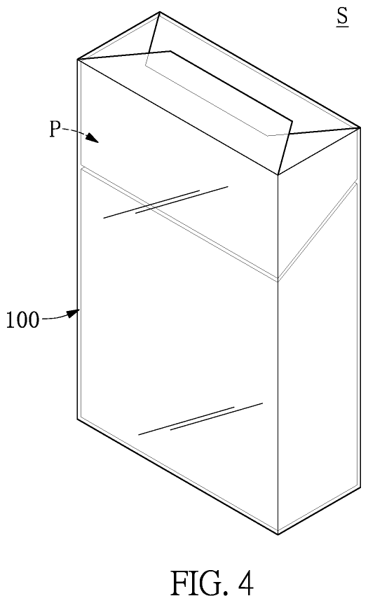

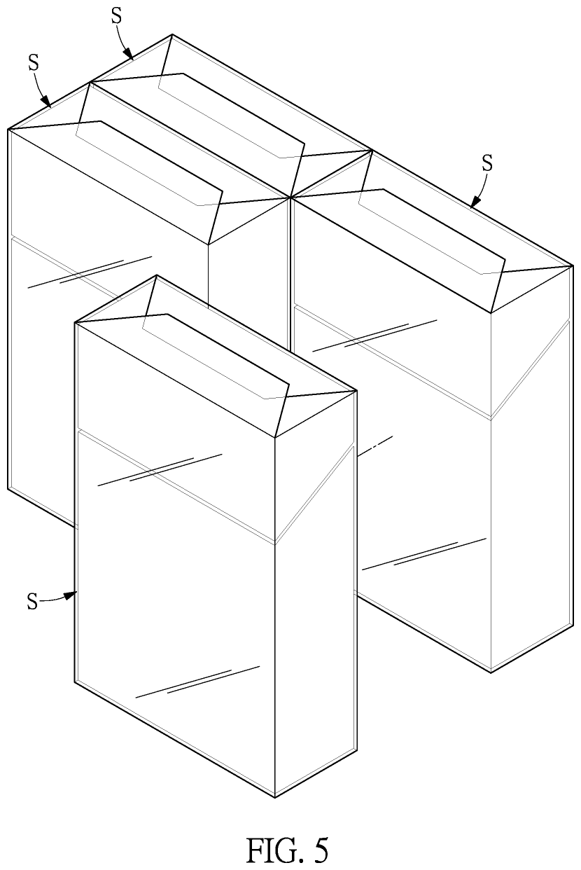

As shown in FIG. 4 and FIG. 5, the step S130 includes: packaging the plurality of inner packaging films 100 respectively on outer surfaces of the plurality of carton products P to form a plurality of inner packaging structures S. That is, each of the inner packaging structures S includes one carton product P and one inner packaging film 100 packaged on the outer surface of the one carton product P.

As shown in FIG. 6 and FIG. 7, the step S140 includes: providing an outer packaging film 200, in which a composition of the outer packaging film 200 includes: a second polypropylene material 201, a second resin additive 202 mixed in the second polypropylene material 201, and a slip agent 203 dispersed in the second polypropylene material 201 in a form of a plurality of particles.

The second polypropylene material 201 has a second melting point. The first melting point of the first polypropylene material 101 is greater than the second melting point of the second polypropylene material 201, and an absolute value of a difference between the first melting point and the second melting point is between 10° C. and 40° C.

More specifically, the second melting point is between 120° C. and 140° C., which is less than the first melting point of between 140° C. and 160° C. Furthermore, the melting point of the second resin additive 202 is between 95° C. and 140° C., and the melting point of the second resin additive 202 is not greater than the melting point of the first resin additive 102 (between 130° C. and 160° C.), but the present disclosure is not limited thereto.

The second resin additive 202 is also not a polypropylene material, and a material type of the second resin additive 202 is different from a material type of the first resin additive 102. In addition, a melting point of the second resin additive 202 is not greater than the second melting point.

Based on a total weight of the outer packaging film 200 being 100 wt %, a content range of the second polypropylene material 201 is not less than 35 wt %, a content range of the second resin additive 202 is between 5 wt % and 50 wt %, and a content range of the slip agent 203 is between 0.1 wt % and 10 wt %.

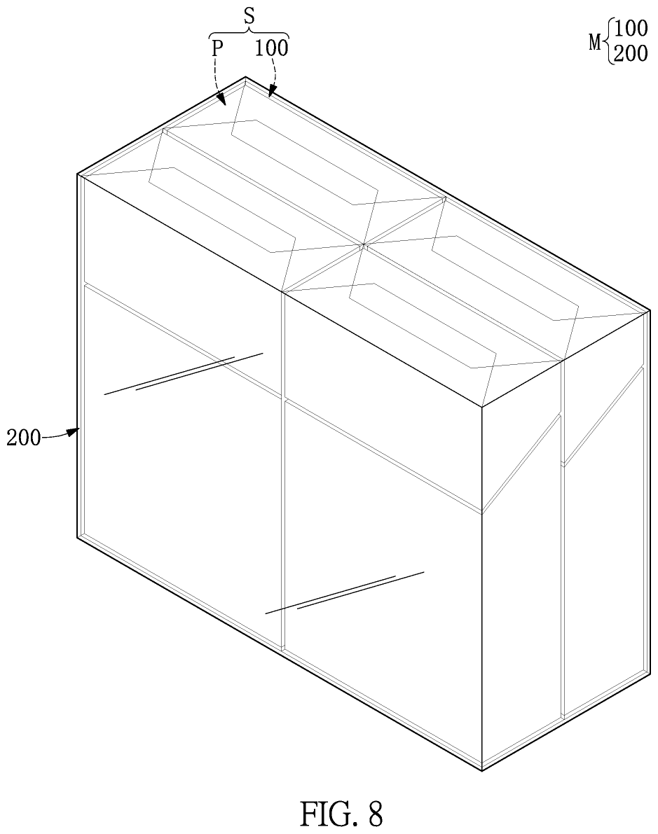

As shown in FIG. 8, the step S150 includes: packaging the outer packaging film 200 on an outer side of the plurality of inner packaging structures S to accommodate the plurality of inner packaging structures S. Therefore, the plurality of inner packaging structures S can be packaged into a group of products, thereby improving the transportation efficiency of the products, or improving the marketability of the products.

It is worth mentioning that, in the step S130, the plurality of inner packaging films 100 are firstly and respectively packaged on the outer surfaces of the plurality of carton products P through a heat-sealing film process to form the plurality of inner packaging structures S, and a peeling force of each of the inner packaging films 100 itself is between 1.2N and 8.0N.

Furthermore, in the step S150, the outer packaging film 200 is then packaged on the outer side of the plurality of inner packaging structures S through the heat-sealing film process to accommodate the plurality of inner packaging structures S. The peeling force of the outer packaging film 200 itself is between 2.0N and 10.0N, and the peeling force between the outer packaging film 200 and each of the inner packaging films 100 is not greater than 0.5N, and is preferably between 0.01N and 0.40N. In other words, the peeling force between the outer packaging film 200 and each inner packaging film 100 is much smaller than the peeling force of the outer packaging film 200 itself, and also much smaller than the peeling force of the inner packaging film 100 itself.

### Experimental Data and Test Results

Hereinafter, the content of the present disclosure will be described in detail with reference to Exemplary Examples 1 to 2 and Comparative Examples 1 to 4. However, the following examples are only used to help understand the present disclosure, and the scope of the present disclosure is not limited to these examples.

Exemplary Example 1 includes: completing the package of the carton products according to the packaging method for the carton products in the above embodiment. In the inner packaging film, the first resin additive is poly(methyl methacrylate) (PMMA). In the outer packaging film, the second resin additive is low-density polyethylene (LDPE), and the slip agent is polydimethylsiloxane particles.

The packages of the carton products completed in Exemplary Examples 1 to 2 and Comparative Examples 1 to 4 were tested for peeling force. The related test method is described as follows, and the related test results are summarized in Table 1.

The peeling force test includes: testing the heat-sealed outer/inner packaging film, outer/outer packaging film and inner/inner packaging film with a universal testing machine (SHIMADZU AG-X) in accordance with ASTM F1921.

### Table 1 Shows Experimental Parameters and Test Results of Exemplary Examples and Comparative Examples

| | | Exemplary | Exemplary | Comparative | Comparative | Comparative | Comparative |
|---|---|---|---|---|---|---|---|
| item | | Example 1 | Example 2 | Example 1 | Example 2 | Example 3 | Example 4 |
| inner | content of first | 99 | 99 | 100 | 99 | 100 | 100 |
| packaging | polypropylene | | | | | | |
| film | material (wt %) | | | | | | |
| | melting point of | 145 | 145 | 145 | 145 | 133 | 145 |
| | first polypropylene | | | | | | |
| | material (° C.) | | | | | | |
| | content of first | 1 | 1 | 0 | 1 | 0 | 0 |
| | resin additive (wt %) | | | | | | |
| | melting point | 140 | 140 | — | 140 | — | — |
| | of first resin | | | | | | |
| | additive (° C.) | | | | | | |
| outer | content of second | 74 | 72 | 74 | 94 | 100 | 100 |
| packaging | polypropylene | | | | | | |
| film | material (wt %) | | | | | | |
| | melting point of | 133 | 133 | 133 | 133 | 145 | 133 |
| | second polypropylene | | | | | | |
| | material (° C.) | | | | | | |
| | content of second | 20 | 20 | 20 | 0 | 0 | 0 |
| | resin additive (wt %) | | | | | | |
| | melting point of | 110 | 110 | 110 | — | — | — |
| | second resin | | | | | | |
| | additive (° C.) | | | | | | |
| | content of slip | 6 | 8 | 6 | 6 | 0 | 0 |
| | agent (wt %) | | | | | | |
| Test | peeling force of | 1.66 | 1.66 | 1.03 | 1.66 | 2.02 | 1.03 |
| Results | inner packaging | | | | | | |
| | film itself (N) | | | | | | |
| | peeling force of | 2.24 | 1.96 | 2.24 | 1.67 | 1.03 | 2.02 |
| | outer packaging | | | | | | |
| | film itself (N) | | | | | | |
| | peeling force | 0.12 | 0.09 | 0.10 | 0.08 | 1.98 | 1.22 |
| | between inner | | | | | | |
| | packaging film and | | | | | | |
| | outer packaging | | | | | | |
| | film (N) | | | | | | |

### Discussion of Test Results

In Exemplary Example 1, the inner packaging film includes 99 parts by weight of polypropylene having a melting point of 145° C., and the inner packaging film is added with 1 part by weight of a first resin additive having a melting point of 140° C. The first resin additive is used to enhance the peeling force of the inner packaging film itself after heat sealing, and the peeling force is 1.66N. The outer packaging film includes 74 parts by weight of polypropylene having a melting point of 133° C. The melting point (133° C.) of the main resin material polypropylene of the outer packaging film is less than the melting point (145° C.) of the main resin material polypropylene of the inner packaging film, so as to avoid excessively high peeling force between the outer packaging film and the inner packaging film, and to avoid the mutual adhesion between the outer packaging film and the inner packaging film. In addition, the outer packaging film is added with 20 parts by weight of a second resin additive having a melting point of 110° C. The second resin additive is used to enhance the peeling force of the outer packaging film itself after heat sealing, and the peeling force is 2.24N. The second resin additive of the outer packaging film and the first resin additive of the inner packaging film are of different material types, so as to prevent the outer packaging film and the inner packaging film from sticking to each other due to the principle of the heterogeneous incompatibility. That is, the outer packaging film and the inner packaging film are difficult to be heat-sealed with each other. In addition, the outer packaging film is added with 6 parts by weight of a slip agent to prevent the outer packaging film and the inner packaging film from sticking to each other, and the peeling force between the outer packaging film and the inner packaging film is 0.12N.

In Exemplary Example 2, the raw materials of the inner packaging film are the same as that of Exemplary Example 1. The content of the slip agent in the raw materials of the outer packaging film is increased to 8 parts by weight. The test results show that the peeling force of the outer packaging film itself is reduced to 1.96N. The peeling force between the outer packaging film and the inner packaging film is reduced to 0.09N. The test results show that the slip agent does have the effect of reducing the peeling force between the outer packaging film and the inner packaging film, so as to reduce the mutual adhesion between the outer packaging film and the inner packaging film.

In Comparative Example 1, the content of the first resin additive in the raw materials of the inner packaging film is reduced to 0 parts by weight. The raw materials of the outer packaging film are the same as that of Exemplary Example 1. The peeling force of the inner packaging film itself is reduced to 1.03N. The peeling force between the outer packaging film and the inner packaging film is reduced to 0.10N. The test results show that the first resin additive does enhance the peeling force of the inner packaging film itself after heat sealing (the self-adhesive effect of the inner packaging film).

In Comparative Example 2, the raw materials of the inner packaging film are the same as that of Exemplary Example 1. The content of the second resin additive in the raw materials of the outer packaging film is reduced to 0 parts by weight. The peeling force of the outer packaging film itself is reduced to 1.67N. The peeling force between the outer packaging film and the inner packaging film is reduced to 0.08N. The test results shows that the second resin additive does enhance the peeling force of the outer packaging film itself after heat sealing (the self-adhesive effect of the outer packaging film).

In Comparative Example 3, the inner packaging film includes 100 parts by weight of polypropylene having a melting point of 133° C. The peeling force of the inner packaging film itself is 2.02N. The outer packaging film includes 100 parts by weight of polypropylene having a melting point of 145° C. The peeling force of the outer packaging film itself is 1.03N. The melting point (145° C.) of the main resin material polypropylene of the outer packaging film is greater than the melting point (133° C.) of the main resin material polypropylene of the inner packaging film. The test results show that the peeling force between the outer packaging film and the inner packaging film is 1.98N.

In Comparative Example 4, the difference between Comparative Example 4 and Comparative Example 3 is that the raw materials of the inner packaging film and the raw materials of the outer packaging film are interchanged with each other. The inner packaging film includes 100 parts by weight of polypropylene having a melting point of 145° C. The peeling force of the inner packaging film itself is 1.03N. The outer packaging film includes 100 parts by weight of polypropylene having a melting point of 133° C. The peeling force of the outer packaging film itself is 2.02N. In this situation, the melting point (133° C.) of the main resin material polypropylene of the outer packaging film is less than the melting point (145° C.) of the main resin material polypropylene of the inner packaging film. The peeling force between the outer packaging film and the inner packaging film is 1.22N, which is less than the 1.98N of Comparative Example 3, and obviously helps to reduce the mutual adhesion between the outer packaging film and the inner packaging film.

### Beneficial Effects of Embodiments

In conclusion, the packaging material for carton products and the packaging method thereof of the present disclosure can effectively prevent the inner packaging film and the outer packaging film from sticking to each other, and can improve the self-adhesiveness of the inner packaging film and the self-adhesiveness of the outer packaging film by virtue of “adjusting a melting point matching relationship between the inner packaging film and the outer packaging film”, by virtue of “respectively introducing different resin additives into the inner packaging film and the outer packaging film”, and by virtue of “introducing a slip agent into the outer packaging film”.

Furthermore, since neither the inner packaging film nor the outer packaging film of the present disclosure has a coating layer, the technical defects in the prior art of “packaging films being easy to release pungent gas” and “the need to add double-sided coating equipment in production” can also be effectively improved.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A packaging material for a carton product, comprising:
an inner packaging film used for packaging an outer surface of the carton product; wherein a composition of the inner packaging film includes:
a first polypropylene material having a first melting point; and
a first resin additive mixed in the first polypropylene material; wherein the first resin additive is not a polypropylene material, and a melting point of the first resin additive is not greater than the first melting point;
wherein based on a total weight of the inner packaging film being 100 wt %, a content range of the first polypropylene material is not less than 50 wt %, and a content range of the first resin additive is between 0.1 wt % and 10 wt %; and
an outer packaging film used for packaging an outer surface of the inner packaging film away from the carton product; wherein a composition of the outer packaging film includes:
a second polypropylene material having a second melting point; wherein the first melting point is greater than the second melting point, and an absolute value of a difference between the first melting point and the second melting point is between 10° C. and 40° C.;
a second resin additive mixed in the second polypropylene material; wherein the second resin additive is also not a polypropylene material, a material type of the second resin additive is different from a material type of the first resin additive, and a melting point of the second resin additive is not greater than the second melting point; and
a slip agent dispersed in the second polypropylene material in a form of a plurality of particles;
wherein based on a total weight of the outer packaging film being 100 wt %, a content range of the second polypropylene material is not less than 35 wt %, a content range of the second resin additive is between 5 wt % and 50 wt %, and a content range of the slip agent is between 0.1 wt % and 10 wt %;
wherein a peeling force between the outer packaging film and the inner packaging film is not greater than 0.5N.

2. The packaging material according to claim 1, wherein the first melting point is between 140° C. and 160° C., and the second melting point is between 120° C. and 140° C.

3. The packaging material according to claim 1, wherein the melting point of the first resin additive is between 130° C. and 160° C., and the melting point of the second resin additive is between 95° C. and 140° C.; wherein the melting point of the second resin additive is not greater than the melting point of the first resin additive.

4. The packaging material according to claim 3, wherein the first resin additive is poly(methyl methacrylate) (PMMA), and the second resin additive is at least one material selected from the group consisting of high-density polyethylene (HDPE), low-density polyethylene (LDPE), linear low-density polyethylene (LLDPE), and ethylene-vinyl acetate copolymer (EVA).

5. The packaging material according to claim 1, wherein an average particle size of the slip agent ranges from 0.15 micrometers to 1.5 micrometers; wherein the slip agent is at least one material selected from the group consisting of acrylic particles, silica particles, and polydimethylsiloxane particles.

6. A packaging method for carton products, comprising:
providing a plurality of carton products;
providing a plurality of inner packaging films; wherein a composition of each of the inner packaging films includes: a first polypropylene material and a first resin additive mixed in the first polypropylene material; wherein the first polypropylene material has a first melting point, the first resin additive is not a polypropylene material, and a melting point of the first resin additive is not greater than the first melting point; wherein based on a total weight of the inner packaging film being 100 wt %, a content range of the first polypropylene material is not less than 50 wt %, and a content range of the first resin additive is between 0.1 wt % and 10 wt %;
packaging the plurality of inner packaging films respectively on outer surfaces of the plurality of carton products to form a plurality of inner packaging structures;
providing an outer packaging film; wherein a composition of the outer packaging film includes: a second polypropylene material, a second resin additive mixed in the second polypropylene material, and a slip agent dispersed in the second polypropylene material in a form of a plurality of particles; wherein the second polypropylene material has a second melting point, the first melting point is greater than the second melting point, and an absolute value of a difference between the first melting point and the second melting point is between 10° C. and 40° C.; wherein the second resin additive is also not a polypropylene material, a material type of the second resin additive is different from a material type of the first resin additive, and a melting point of the second resin additive is not greater than the second melting point; wherein based on a total weight of the outer packaging film being 100 wt %, a content range of the second polypropylene material is not less than 35 wt %, a content range of the second resin additive is between 5 wt % and 50 wt %, and a content range of the slip agent is between 0.1 wt % and 10 wt %; and
packaging the outer packaging film on an outer side of the plurality of inner packaging structures to accommodate the plurality of inner packaging structures;
wherein a peeling force between the outer packaging film and each of the inner packaging films is not greater than 0.5N.

7. The packaging method according to claim 6, wherein the first melting point is between 140° C. and 160° C., and the second melting point is between 120° C. and 140° C.

8. The packaging method according to claim 7, wherein the melting point of the first resin additive is between 130° C. and 160° C., and the melting point of the second resin additive is between 95° C. and 140° C.; wherein the melting point of the second resin additive is not greater than the melting point of the first resin additive.

9. The packaging method according to claim 6, wherein the plurality of inner packaging films are firstly and respectively packaged on the outer surfaces of the plurality of carton products through a heat-sealing film process to form the plurality of inner packaging structures, and a peeling force of each of the inner packaging films itself is between 1.2N and 8.0N.

10. The packaging method according to claim 9, wherein the outer packaging film is then packaged on the outer side of the plurality of inner packaging structures through the heat-sealing film process to accommodate the plurality of inner packaging structures; wherein a peeling force of the outer packaging film itself is between 2.0N and 10.0N, and the peeling force between the outer packaging film and each of the inner packaging films is between 0.01N and 0.40N.
